(19) United States
(12) Patent Application Publication
(10) Pub. No.: US 2021/0075222 A1
(43) Pub. Date: Mar. 11, 2021

(54) HYBRID POWER SYSTEM WITH REGENERATIVE INVERTER AND METHOD OF USING SAME

(71) Applicant: Nimbus Power Systems, LLC, Groton, CT (US)

(72) Inventors: Matthew Paul Wilson, Groton, CT (US); Samuel Jordan Angles, Groton, CT (US)

(73) Assignee: Nimbus Power Systems, LLC, Groton, CT (US)

(21) Appl. No.: 16/997,662

(22) Filed: Aug. 19, 2020

Related U.S. Application Data
(60) Provisional application No. 62/927,781, filed on Oct. 30, 2019.
(60) Provisional application No. 62/897,499, filed on Sep. 9, 2019.

(51) Int. Cl. H02J 3/46; F01P 3/20; H02J 3/38

(52) U.S. Cl. CPC H02J 3/46; F01P 3/20; H02J 2300/28; H02J 2300/24; H02J 3/381

(57) ABSTRACT

A hybrid power system controller may be used in conjunction with a hybrid power system including a renewable power generator, a non-renewable power generator, a battery pack, and a regenerative inverter. The hybrid power system controller may include a processor, an external load requirement monitor operably coupled to the processor and configured to measure energy consumption data, and a renewable power generator monitor operably coupled to the processor and configured to measure renewably energy output data. The processor may be configured to control at least one of the renewable power generator, the non-renewable power generator, the battery pack, and the regenerative inverter in response to the measured energy consumption data and the renewable energy output data.

### CROSS-REFERENCE TO RELATED APPLICATIONS

This application claims the benefit of U.S. Provisional Application No. 62/927,781 filed Oct. 30, 2019 and U.S. Provisional Application No. 62/897,499 filed Sep. 9, 2019, each of which is incorporated herein by reference in its entirety.

### BACKGROUND OF THE DISCLOSURE

Off-grid power systems provide power to an external power requirement without relying on a central power grid. The external power requirement, which may be an individual home or business, or a group of grid-tied homes or businesses, will fluctuate based on demand for power over a period of time. Hybrid off-grid power systems may use more than one power source to meet the external power requirement, including power generators or renewable energy sources such as wind, solar, or water. Supply of power from more than one power source enables users of off-grid hybrid power systems to meet the external load with minimal or no reliance on a central power grid.

Hybrid power systems may provide sufficient power to meet the external power requirement by sourcing power from a plurality of power sources, including a renewable power source and a generator, and storing sourced and unused power in a power storage device, such as a battery. Hybrid power systems may integrate solar arrays and a generator to create a hybrid power system for residential use, however these systems may not efficiently direct the source and supply of power and to control thermal conditions of the power system components. Thus, hybrid power systems may be unable to efficiently process and control where renewable power input in excess of the external load requirement is sent, resulting in inefficient use of renewable energy and reduced lifespan of system components.

Accordingly, there is a need for a hybrid power system that includes a regenerative inverter configured for simultaneously meeting an external load requirement and charging a power storage device by modifying the voltage of the regenerative inverter to direct excess power to a power storage device or pull power from the power storage device to the external load, depending on the load's requirements and the available renewable energy. Further, there is a need for a hybrid power system equipped with a thermal monitoring and control system to monitor and control power allocation based on component thermal conditions and predicted renewable power availability.

### BRIEF DESCRIPTION

According to an aspect, the exemplary embodiments include a hybrid power system rated for providing electrical power to power an external alternating current power requirement, the hybrid power system comprising a plurality of power generators coupled to the external alternating current power requirement and configured for supplying power to the external alternating current power requirement; at least one battery pack coupled to at least one of the power generators and the external alternating current power requirement, the battery pack configured for receiving and storing power from at least one of the power generators and for supplying power to the external alternating current power requirement; a regenerative inverter connected to the plurality of power generators, the battery pack, and the external alternating current power requirement, the regenerative inverter configured for converting alternating current power to direct current power and for converting direct current power to alternating current power; and a controller in communication with each of the plurality of power generators, the battery pack, and the regenerative inverter and configured to monitor and control a power supply from each power generator of the plurality of power generators to the battery pack, and a power supply from each power generator of the plurality of power generators and the battery pack to the external alternating current power requirement.

According to an aspect, the exemplary embodiments include a hybrid power system controller for reducing consumption of non-renewable power sources by a hybrid power system including a renewable power generator, a non-renewable power generator, a battery pack, and a regenerative inverter, comprising a processor, and at least one environmental monitor operably coupled to the processor and configured to measure at least one environmental characteristic, wherein the processor is configured to control at least one of the renewable power generator, the non-renewable power generator, the battery pack, and the regenerative inverter in response to the measured environmental characteristic.

According to an aspect, the exemplary embodiments include a method of controlling a thermal management system comprising two cooling loops within a hybrid power system, the method comprising setting an acceptable temperature range for a system component connected to a second cooling loop; monitoring system component temperature data; and initiating a first cooling loop in response to a temperature level of the system component connected to the second cooling loop being outside the acceptable temperature range.

### BRIEF DESCRIPTION OF THE DRAWINGS

A more particular description will be rendered by reference to exemplary embodiments that are illustrated in the accompanying figures. Understanding that these drawings depict exemplary embodiments and do not limit the scope of this disclosure, the exemplary embodiments will be described and explained with additional specificity and detail through the use of the accompanying drawings in which:

FIG. 1 is a schematic diagram of a hybrid power system according to an embodiment;

FIG. 2 is a schematic diagram of a power control system of the hybrid power system, according to an embodiment;

FIG. 3 is a schematic diagram of a low temperature cooling loop of the hybrid power system, according to an embodiment;

FIG. 4 is a schematic diagram of a high temperature cooling loop of the hybrid power system, according to an embodiment; and

FIG. 5 is a diagram of a controller communication network of the hybrid power system, according to an embodiment.

Various features, aspects, and advantages of the exemplary embodiments will become more apparent from the following detailed description, along with the accompanying drawings in which like numerals represent like components throughout the figures and detailed description. The various described features are not necessarily drawn to scale in the drawings but are drawn to emphasize specific features relevant to some embodiments.

The headings used herein are for organizational purposes only and are not meant to limit the scope of the disclosure or the claims. To facilitate understanding, reference numerals have been used, where possible, to designate like elements common to the figures.

### DETAILED DESCRIPTION

Reference will now be made in detail to various embodiments. Each example is provided by way of explanation and is not meant as a limitation and does not constitute a definition of all possible embodiments.

For purposes of this disclosure, “renewable power source” and “renewable energy” refer to power or energy that is collected from renewable resources, which are naturally replenished on a human timescale. For purposes of this disclosure, renewable power sources may include, but are not limited to, wind, solar, geothermal, hydroelectricity, biomass, and biofuel. “Non-renewable power” and “non-renewable energy” refer to power or energy that are not replenished on a human timescale or that include carbon as a main element. Non-renewable power sources may include, but are not limited to, fossil fuels such as coal, petroleum, and natural gas.

Embodiments described herein relate generally to systems and methods for a hybrid power system. For purposes of this disclosure, the phrases “devices,” “systems,” and “methods” may be used either individually or in any combination referring without limitation to disclosed components, grouping, arrangements, steps, functions, or processes.

For purposes of illustrating features of the embodiments, an exemplary embodiment will now be introduced and referenced throughout the disclosure. This example is illustrative and not limiting and is provided for illustrating the exemplary features of a hybrid power system as described throughout this disclosure.

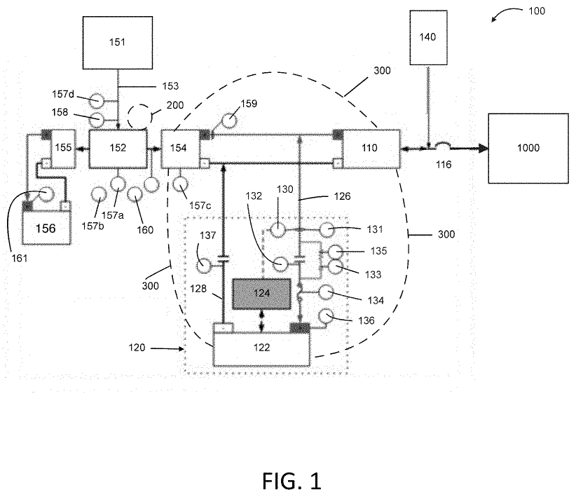

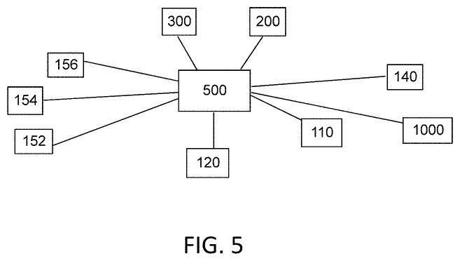

Turning to FIG. 1, a schematic diagram is provided that illustrates the components of the hybrid power system 100 according to an embodiment. The hybrid power system 100 may include a plurality of power generators 140, 152, a battery pack 122, a power control system 110, a thermal management system 200, 300, and a controller 500 (FIG. 5). According to an aspect and as seen in FIG. 1, the plurality of power generators may include a first power generator 140 and a second power generator 152. According to an aspect, the first power generator 140 is an alternating current power generator, and the second power generator 152 is a direct current power generator. The first power generator 140 may be a renewable power generator, meaning the power generator may be powered by a renewable power source such as wind, solar, hydroelectricity, biomass, or biofuel. The second power generator 152 may be a non-renewable power generator, meaning the power generator may be powered by a non-renewable or fuel-based power source. In an embodiment, the second power generator 152 is a propane engine. As shown in FIG. 1, both the first and second power generators 140, 152 provide a power output that can be directed to the external load requirement 1000. According to an aspect, the configuration of the hybrid power system 100 allows the hybrid power system 100 to both meet an external power requirement 1000 and store unused power to be accessed at a later time during which either the external load requirement 1000 increases or availability of power from the first power generator 140 decreases.

According to an aspect, the hybrid power system 100 can replace an end user's connection to a central power grid to be used as a primary source of electrical power to meet an external load requirement 1000. The hybrid power system 100 may also be used as a backup source of electrical power. When used as a backup source of power, the external load requirement 1000 may be connected both to the hybrid power system 100 and to a traditional, central utility grid (not shown) to source power traditionally from a utility. The external load requirement 1000 may be an individual home or business, or a mini-grid formed from a group of homes or businesses. According to an aspect, the hybrid power system may provide a continuous power supply up to 15 kW, up to 24 kW of intermitted power, and/or up to 30 kW of surge power. In an embodiment, the hybrid power system 100 provides power as needed by the external load's requirement. The hybrid power system 100 may provide 0 amps of power when no power is needed by the external load requirement, or, according to an aspect, the hybrid power system 100 may provide a continuous power supply of at least 25 amps, and up to 100 amps as required by the external load. According to an aspect, the hybrid power system provides at least 25 amps of service to an external alternating current requirement. In a further embodiment, the hybrid power system 100 may provide at least 50 amps of service to an external alternating current requirement. In an embodiment, the hybrid power system provides current as split phase 120/240V at 60 Hz, the North American standard. Alternatively, the hybrid power system 100 may be configured for non-North American standard voltage and frequency. For example, the hybrid power system 100 may provide power to an external load requiring a power supply of 230V, or to an external load requiring a voltage frequency of 50 Hz. The hybrid power system 100 may be configured to run in parallel (not shown) with one or more other hybrid power systems to meet a higher power load requirement. For example, the hybrid power system may run in parallel with at least one other hybrid power system to supply at least 50 amps of service to an external alternating current requirement. In a further embodiment, the hybrid power system may be run in parallel with other hybrid power systems to supply at least 100 amps of service to an external alternating current requirement. According to an aspect, a plurality of hybrid power systems may be run in parallel to provide a power supply of up to 400 amps or more. In an embodiment, the hybrid power system provides at least three hours of 100 amp service with a 15 kW non-renewable generator and 35 kWh of energy storage for a stationary stand-by or off-grid power application. In an embodiment in which the first power generator 140 is a renewable power source, the hybrid power system 100 is configured for a continuous power output of 15 kW, or 24 kW for 3 hours, or 30 kW for 5 seconds in power surge conditions without power input from the first power generator 140. According to an aspect, the hybrid power system 100 may be configured to provide power at any required power level, or to include a component providing power at any required power level.

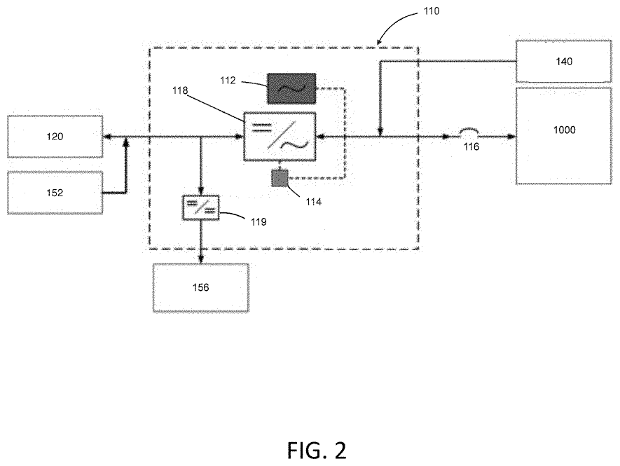

According to an aspect and with reference again to FIG. 1, the first power generator 140 generates power that is supplied directly to the external load requirement 1000, which may be an alternating current power requirement. A breaker 116 may be provided between the hybrid power system 100 and the external load requirement 1000 to disrupt power supplied by the first power generator 140 to the external load requirement 1000. The breaker 116 may be utilized in the system 100 to protect the first power generator 140, the regenerative inverter 118, or the external load requirement 1000 from unexpected fluctuations in power output or load requirement. The first power generator 140 and external load requirement 1000 are each connected to a power control system 110, shown in schematic detail in FIG. 2. According to an aspect, the power control system 110 may include means, such as voltage or frequency sensors, for monitoring data relating to energy output of the first and second power generators 140, 152 and energy consumption of the external load requirement 1000. According to an embodiment and with reference to FIG. 2, the power control system 110 may include control components of the regenerative inverter 118 including a voltage control 114 configured to set the voltage of the regenerative inverter 118, and a frequency control 112 configured to set the frequency of the regenerative inverter 118. When the power output of the first power generator 140 exceeds the external load requirement 1000, any excess energy is directed through a regenerative inverter 118 for storage in the battery pack 122. The voltage control 114 of the power control system 110 provides voltage regulation by directing excess power output from the first power generator 140 to be sunk or stored in the battery pack 122, or sources additional power from one of the battery pack 122 or second power generator 152 when the power output of the first power generator 140 is insufficient to meet the external load requirement.

As illustrated in FIG. 2, the power control system 110 may include a regenerative inverter 118 for conversion of alternating current (“AC”) power to direct current (“DC”) power and DC power to AC power within the hybrid power system 100. According to an aspect, the regenerative inverter 118 converts excess AC power from the first power generator 140 to be stored as DC power in the battery pack 122, and converts DC power output from the second generator 152 to supply the external load requirement 1000. In an embodiment, the power control system 110 may include a DC-DC down converter 119 for reducing voltage of the power supply to a 12V charger 156, which may be used as a starter battery for the second power generator 152.

With reference to FIG. 1, the second power generator 152 is connected to an alternator 154 and a rectifier (not shown). In an embodiment, the second power generator power output is DC power, and the alternator 154 provides rectified DC voltage and current to the hybrid power system 100. The alternator 154 is configured to provide power to the battery pack 122 of the power storage system 120 for battery charging and to the external load requirement 1000 to meet the power requirement. According to an aspect, the alternator 154 may be configured to provide power directly to the regenerative inverter 118. According to an aspect, the second power generator 152 may be an engine, and the alternator 154 may be directly mounted to the engine, such as a Kubota 22 kWnet propane engine (for example, model number WG972-L-E4). In an embodiment, the engine may take a variety of fuels (e.g., natural gas, diesel, and propane). A fuel source 151, such as a propane fuel tank, provides fuel to the second power generator 152 through a fuel line 153. According to an aspect, the alternator 154 provides 15 kW of rated power, and may provide a voltage range of 0 to 384 Vdc with a nominal voltage of 345 Vdc. The alternator 154 may have a speed range of 0 to 3600 RPM, with a nominal speed of 3200 RPM. The alternator 154 is configured to operate in the hybrid power system 100 at a level of at least 92% efficiency. According to an aspect, the alternator 154 may be a flywheel alternator. According to an aspect, the regenerative inverter 118 supplies power directly to the external alternating requirement 1000. The breaker 160 may also be configured to disrupt power supplied by the regenerative inverter 118 to the external alternating power requirement 1000, for example, to protect the regenerative inverter 118 or the external alternating power requirement 1000 in the event of fluctuations in power output or power demand.

In an embodiment, a starter battery 156, such as a 12V battery, is operably connected to and supplies power to the second power source 152 through alternator 155. According to an aspect, the starter battery 156 may be connected to the power control system 110 and may be charged by the first power generator 140, for example under conditions in which the power output of the first power generator 140 exceeds the external load requirement. Each of the second power generator 152, alternator 154, and starter battery 156 may include one or more monitors for measuring data relating to component conditions, such as engine speed, intake temperature, intake pressure, oil temperature, oil pressure, fuel flow rate, actual throttle position, engine status, available net power, and actual net power. In an embodiment and as shown in FIG. 1, the monitors include a fuel flow rate monitor 158, intake temperature monitor 157d, intake pressure monitor 157b, oil temperature monitor 157a, alternator temperature monitor 157c, alternator current monitor 159, voltage monitor 161, and engine speed monitor 160. The second power generator 152 and alternator 154 may be coupled together and connected to the system 100 with a four-point mounting design (not shown), including two mounts on the second power generator 152 and two mounts on the alternator 154. Each mounting point has an anti-vibration rubber mount that is rated for 45 kg of load. The second power generator 152 may also include an engine compartment for installation of the battery pack 122 and related components.

With reference again to FIG. 1, the battery pack 122 is formed of a plurality of battery cells that are configured in series and/or in parallel. According to an aspect, the battery pack 122 is a 307 Vdc battery pack. In an embodiment, the battery pack 122 is a lithium iron phosphate (LiFePO4) battery, and may have a charge capacity of 35 kWhrs of usable energy. The battery pack 122 may have a minimum voltage of 250 Vdc, a maximum voltage of 435 Vdc, and a nominal voltage of 345 Vdc. According to an aspect, the battery pack 122 may have a normal charge/discharge current of +/−25 Adc, and a maximum charge current of −35 Adc and a maximum discharge current of +135 Adc. At peak, the discharge current may be 33 kW at 250 Vdc. The battery pack 122 may be designed for a lower or higher energy storage level, and/or a lower or higher voltage level.

According to an aspect, the battery pack 122 is included in a power storage system 120. The power storage system 120 may be installed in an engine compartment of the second power generator 152 and configured to operate in environments in which dust, moisture, and contaminants may be present. According to an aspect, the power storage system 120 is configured for wash-down, wherein the electric housings and electrical connections of the power storage system 120 have an Ingress Protection rating of IP67 or higher as defined in international standard EN 60529 to define sealing effectiveness of electrical enclosures against intrusion from foreign bodies and moisture. The power storage system 120 may include a battery circuit 126, 128 for sinking power (at 126) to the battery pack 122 and sourcing power (at 128) from the battery pack 122. The battery circuit 126, 128 is protected by at least one switch 132, 137, such as contactors, that open or close the battery circuit to disable or enable the transmission of power to or from the battery pack 122. A pre-charge contactor 133, pre-charge resistor 135, and fuse 134 for regulating battery charge may be included in the battery circuit adjacent the positive connection (i.e., at 126).

In an embodiment, the power storage system 120 may include a variety of monitors for measuring data relating to component conditions, such as battery pack power level, battery pack voltage, battery pack current, battery cell voltage data, total pack cycle, total pack throughput, and average cell temperature. According to an embodiment and as shown in FIG. 1, the power storage system 120 includes a battery voltage monitor 130, a battery current monitor 131, a battery power monitor 124, and a battery temperature monitor 136.

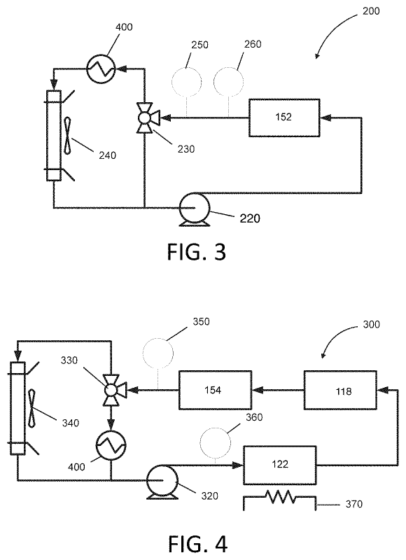

According to an aspect, the hybrid power system 100 may be housed in an outdoor environment, and may operate in ambient temperatures between −30 C and 45 C. The hybrid power system 100 may be used in temperatures outside of this range at a lower power level. Maintenance of an average operating temperature within an acceptable temperature range may promote efficient operation of system components, namely the battery pack 122. In an embodiment, the hybrid power system 100 is housed within an outdoor, weatherproof enclosure (not shown) to protect system components from weather events, to reduce noise, and to help regulate temperature. The hybrid power system 100 may be equipped with a thermal management system including two cooling loops 200, 300 and a heat exchanger 400 (FIGS. 3 and 4) to manage the thermal conditions of the hybrid power system 100. According to an aspect, the first cooling loop 200 may be coupled to at least one of the power generators 140, 152, the second cooling loop 300 may be coupled to the battery pack 122 and the regenerative inverter 118, and the heat exchanger 400 may transfer thermal energy between the first cooling loop 200 and the second cooling loop 300. The cooling loops 200, 300 may be liquid cooling loops. According to an aspect, the cooling loop liquid may have a flow rate of 20 L/min and a specific heat of 3.38 kJ/kg K. The cooling loops 200, 300 may employ a mixture of water and ethylene glycol.

With reference to FIG. 3, the first cooling loop 200 is shown. The first cooling loop/high-temperature cooling loop 200 may be coupled to and regulate the temperature of the second power generator 152. The first cooling loop 200 may also include a flow control valve 230, a radiator or fan 240, a pump 220, and a heat exchanger 400. With reference to FIG. 4, the second cooling loop/low-temperature cooling loop 300 may be coupled to and regulate the temperature of the battery pack 122, alternator 154, and/or regenerative inverter (housed in the power control system 110). In an embodiment, the second cooling loop 300 may include at least one heating element 370 thermally coupled to the battery pack 122, a pump 320, a radiator or fan 340, and a control valve 330. According to an aspect, the heating elements 370 are electrical heating elements.

The first and second cooling loops 200, 300 may include monitors for measuring data relating to the cooling loops, such as temperature monitors 260, 360 and pressure monitors 250, 350. In an embodiment, the first temperature monitor 260 may measure a first cooling loop temperature corresponding to the temperature of the second power generator 152, and a second temperature monitor 360 may measure a second cooling loop temperature corresponding to the temperature of the battery pack 122. If the temperature of the first cooling loop is above or below a predetermined acceptable range, then one or more components coupled to the cooling loops 200, 300 may be initiated to regulate the temperature of the cooling loop. For example, if the second power generator 152 is overheating, the radiator/fan 240 may be started to circulate cooler ambient air to cool the second power generator 152. Similarly, if the temperature of the second cooling loop 300 is above or below a predetermined acceptable range, components may be initiate for temperature regulation. The heating elements 370 may be initiated when the second cooling loop temperature is below the acceptable temperature range to heat the battery pack 122, for example below 10 C. According to an aspect, the second power generator 152 may also turn on to provide heat to the second cooling loop 300 via the heat exchanger 400 in conditions in which the heating elements 370 are insufficient to maintain or increase battery pack temperature within an acceptable temperature range. The radiator 340 may also reject heat to the ambient environment when the battery pack temperature is above an acceptable temperature range, for example above 25 C.

With reference to FIG. 5, the communication network of the hybrid power system 100 including the controller 500 is shown. The controller 500 includes a processor (not shown) that may control the renewable power generator 140, the non-renewable power generator 152, the battery pack 122, and the regenerative inverter 118 in response to data measured by one or more monitors that are operably connected to the processor. The controller 500 may be programmed to send control signals in response to system condition measurements from monitors associated with the components of the hybrid power system 100 to minimize consumption of non-renewable power sources (e.g., fuel for the non-renewable power generator 152) and to minimize the number of times the second power generator 152 must be started to meet the external load, battery pack charge level, and temperature requirements.

The processor may control one or more components of the hybrid power system 100 in response to characteristics of the external hybrid power system environment. According to an aspect, to minimize the number of starts required by the second power generator 152, the controller 500 may estimate and set a battery charge level to which the second power generator 152 should charge the battery pack 122. The charge level may be estimated and set based on a weather forecast generated in response to one or more environmental characteristics that are measured by environmental monitors operably coupled to the processor, such as an external temperature monitor for measuring temperature data, an external pressure monitor for measuring pressure data, and a humidity monitor for measuring humidity data. The processor generates a weather forecast based on the environmental characteristics, and may control one or more components of the hybrid power system 100 in response to the weather forecast.

The charge level may also be estimated and set based on a calculated future level of renewable energy available to the hybrid power system 100. According to an aspect, the controller 500 includes a time keeping device operably connected to the processor for generating a time signal. The processor may calculate the future level of renewable energy based on the weather forecast, and the time signal. The processor will initiate the non-renewable power generator 152 in response to the future level of renewable energy, for example, if the battery pack 122 is below the predetermined charge threshold and the battery pack 122 will not be sufficiently charged by the renewable power source 140, based on the calculated future level of renewable energy available to the hybrid power system 100.

According to an aspect, the controller 500 may additionally include an external load requirement monitor for measuring energy consumption data of the external load requirement 1000, and a renewable power generator monitor for measuring renewable energy output data of the renewable power generator 140. In response to the measured energy consumption data and the measured renewable energy output data, the processor may control one or more of the hybrid power system components. According to an aspect, the external load requirement monitor and the renewable power generator monitor may each include a voltage sensor for measuring voltage data and a current sensor for measuring current data, and the processor may control the voltage or current of the regenerative inverter 118 in response to the measured voltage data or the measured current data. According to an aspect, the processor may adjust the frequency of the regenerative inverter 118 to reduce renewable power output from the renewable power generator 140 when power output from the renewable power generator 140 exceeds the external load requirement 1000 and a charge level of the battery pack 122 exceeds the predetermined charge level threshold. According to an aspect, the frequency of the regenerative inverter 118 may be adjusted from 60 Hz to 61-62 Hz to reduce power output and prevent overcharging of the battery pack 122.

According to an aspect, the controller 500 may include a battery monitor for monitoring the voltage, current, power level, or temperature of the battery pack 122. As discussed above with reference to the thermal management system of FIGS. 3-4, the controller 500 may regulate the battery pack temperature to average 25 C operating temperature. A battery pack temperature monitor 136 may measure battery pack temperature data, and the processor may initiate either the non-renewable power generator 152 or the heating elements 370 in response to the battery pack temperature falling below the predetermined acceptable threshold. The processor may additionally or alternatively be coupled to a battery power monitor 124 that measures the battery charge level data. When the battery power level is outside a predetermined acceptable range, the processor will start or stop the non-renewable power generator 152 based on the measured battery charge level data. If the battery power level is below a predetermined acceptable range, the processor will start the non-renewable generator 152 until a desired charge level is reached, at which point it will shut off the non-renewable generator 152 to conserve fuel. In embodiments in which the non-renewable power generator 152 is an engine that is used to charge the battery pack 122, a battery pack voltage monitor 130 may be operably coupled to the processor for measuring voltage data of the battery pack. The processor may then set the engine of the non-renewable power generator 152 to run at a speed corresponding to the voltage of the battery pack 122. According to an aspect, an engine or alternator temperature monitor 260 may be operably coupled to the processor for measuring the temperature of the engine or alternator 154 associated with the non-renewable power source 152. The controller 500 may set a predetermined acceptable temperature range, and the processor may initiate a radiator or fan 240 to cool the engine 152/alternator 154 via the first cooling loop 200 in response to the temperature being above the acceptable range.

In an embodiment, the renewable power generator 140 of the hybrid power system 100 may be connected to a traditional utility grid by a transfer switch (not shown). The transfer switch may direct the supply of power from the renewable power generator 140 to either the utility grid or the hybrid power system 100. According to an aspect, when the transfer switch is pointing to the utility grid, the renewable power generator 140 will sink power in excess of the external load requirement 1000 to the utility grid. When the transfer switch is pointing to the hybrid power system 100, the renewable power generator 140 will sink power in excess of the external load requirement 1000 to the hybrid power system 100 for storage in the battery pack 122.

According to an aspect, the controller 500 may also include an alarm or an emergency shutdown switch, which the processor may initiate to shut down one or all components of the hybrid power system 100 in response to system condition data measured by monitors coupled to the processor. In an embodiment, the hybrid power system 100 includes a user interface including a manual shutdown switch and a display screen. The user interface may be in communication with the controller 500 to control the hybrid power system 100 or components of the hybrid power system 100.

This disclosure, in various embodiments, configurations and aspects, includes components, methods, processes, systems, and/or apparatuses as depicted and described herein, including various embodiments, sub-combinations, and subsets thereof. This disclosure contemplates, in various embodiments, configurations and aspects, the actual or optional use or inclusion of, e.g., components or processes as may be well-known or understood in the art and consistent with this disclosure though not depicted and/or described herein.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

In this specification and the claims that follow, reference will be made to a number of terms that have the following meanings. The terms “a” (or “an”) and “the” refer to one or more of that entity, thereby including plural referents unless the context clearly dictates otherwise. As such, the terms “a” (or “an”), “one or more” and “at least one” can be used interchangeably herein. Furthermore, references to “one embodiment”, “some embodiments”, “an embodiment” and the like are not intended to be interpreted as excluding the existence of additional embodiments that also incorporate the recited features. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Terms such as “first,” “second,” “upper,” “lower” etc. are used to identify one element from another, and unless otherwise specified are not meant to refer to a particular order or number of elements.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

As used in the claims, the word “comprises” and its grammatical variants logically also subtend and include phrases of varying and differing extent such as for example, but not limited thereto, “consisting essentially of” and “consisting of.” Where necessary, ranges have been supplied, and those ranges are inclusive of all sub-ranges therebetween. It is to be expected that the appended claims should cover variations in the ranges except where this disclosure makes clear the use of a particular range in certain embodiments.

The terms “determine”, “calculate” and “compute,” and variations thereof, as used herein, are used interchangeably and include any type of methodology, process, mathematical operation or technique.

This disclosure is presented for purposes of illustration and description. This disclosure is not limited to the form or forms disclosed herein. In the Detailed Description of this disclosure, for example, various features of some exemplary embodiments are grouped together to representatively describe those and other contemplated embodiments, configurations, and aspects, to the extent that including in this disclosure a description of every potential embodiment, variant, and combination of features is not feasible. Thus, the features of the disclosed embodiments, configurations, and aspects may be combined in alternate embodiments, configurations, and aspects not expressly discussed above. For example, the features recited in the following claims lie in less than all features of a single disclosed embodiment, configuration, or aspect. Thus, the following claims are hereby incorporated into this Detailed Description, with each claim standing on its own as a separate embodiment of this disclosure.

Advances in science and technology may provide variations that are not necessarily express in the terminology of this disclosure although the claims would not necessarily exclude these variations.

What is claimed is:

1. A hybrid power system rated for providing electrical power to power an external alternating current power requirement, the hybrid power system comprising:
a first power generator configured for supplying power directly to the external alternating current power requirement;
a second power generator is configured for supplying power directly to the external alternating current power requirement;
a battery pack coupled to the external alternating current power requirement and at least one of the first power generator and the second power generator, the battery pack configured for receiving and storing power from at least one of the first power generator and the second power generator and for supplying power to the external alternating current power requirement;
a regenerative inverter coupled to each of the first power generator and the second power generator, the battery pack, and the external alternating current power requirement, the regenerative inverter configured for converting alternating current power to direct current power and for converting direct current power to alternating current power; and
a controller in communication with each of the first power generator, the second power generator, the battery pack, and the regenerative inverter and configured to:
monitor and control a power supply from the first power generator power generator and the second power generator to the battery pack, and
monitor and control a power supply from the first power generator, the second power generator, and the battery pack to the external alternating current power requirement,
wherein:
the first power generator is configured for supplying power to the regenerative inverter,
the second power generator is configured for supplying power directly to at least one of the regenerative inverter and the battery pack, and
the regenerative inverter is configured for supplying power directly to the external alternating current power requirement.

2. The hybrid power system of claim 1, wherein the first power generator is an alternating current power generator configured to generate power from a renewable source selected from a group comprising wind, solar, hydroelectricity, biomass, and biofuel.

3. The hybrid power system of claim 1, wherein the second power generator is a direct current power generator, comprising:
an engine;
a starter battery operably coupled to the engine; and
an alternator operably coupled to an output of the engine, the alternator being configured to provide power directly to at least one of the regenerative inverter and the battery pack.

4. The hybrid power system of claim 1, further comprising:
a frequency control configured to set the frequency of the regenerative inverter; and
a voltage control configured to set the voltage of the regenerative inverter.

5. The hybrid power system of claim 1, further comprising:
a first cooling loop coupled to at least one of the plurality of power generators and comprising a first temperature monitor configured to measure a first cooling loop temperature;
a second cooling loop coupled to the battery pack and the regenerative inverter and comprising a second temperature monitor configured to measure a second cooling loop temperature;
a heat exchanger configured to transfer thermal energy between the first cooling loop and the second cooling loop; and
a heating element thermally coupled to the battery pack,
wherein the heating element is configured to start in response to the second cooling loop temperature being outside a predetermined temperature range.

6. The hybrid power system of claim 5, wherein the first cooling loop is coupled to the second power generator, and wherein the second power generator is configured to start in response to the second cooling loop temperature being outside the predetermined temperature range.

7. The hybrid power system of claim 1, further comprising:
a user interface including a manual shutdown switch and a display screen, the user interface being in communication with the controller and configured to control the hybrid power system or components of the hybrid power system.

8. The hybrid power system of claim 1, wherein the hybrid power system is configured to provide at least 25 amps of service to an external alternating requirement.

9. The hybrid power system of claim 8, wherein the hybrid power system is configured to run in parallel with at least one other hybrid power system to supply at least 50 amps of service to an external alternating current requirement.

10. A hybrid power system controller for reducing consumption of non-renewable power sources by a hybrid power system including a renewable power generator, a non-renewable power generator, a battery pack, and a regenerative inverter, comprising:
a processor; and
at least one environmental monitor operably coupled to the processor and configured to measure at least one environmental characteristic,
wherein the processor is configured to control at least one of the renewable power generator, the non-renewable power generator, the battery pack, and the regenerative inverter in response to the measured environmental characteristic.

11. The hybrid power system controller of claim 10, the at least one environmental monitor selected from the group consisting of:
an external temperature monitor operably coupled to the processor and configured to measure temperature data;
an external pressure monitor operably coupled to the processor and configured to measure pressure data;
a humidity monitor operably coupled to the processor configured to measure humidity data,
wherein the processor is configured to:
generate a weather forecast in response to the temperature data, pressure data, and humidity data, and
control at least one of the renewable power generator, the non-renewable power generator, the battery pack, and the regenerative inverter in response to the weather forecast.

12. The hybrid power system controller of claim 11, further comprising:
a time keeping device operably coupled to the processor and configured to generate a time signal,
wherein the processor is further configured to calculate a future level of renewable energy based on the weather forecast and the time signal.

13. The hybrid power system controller of claim 12, wherein the processor is configured to initiate power supply from the non-renewable power generator in response to the future level of renewable energy.

14. The hybrid power system controller of claim 10, further comprising:
a battery temperature monitor operably coupled to the processor and configured to measure a battery pack temperature of the battery pack,
wherein the processor is configured to initiate power supply from the non-renewable power generator in response to the battery pack temperature being outside a predetermined acceptable temperature range.

15. The hybrid power system of claim 10, further comprising:
a battery power monitor operably coupled to the processor and configured to measure battery power level data,
wherein the processor is configured to initiate or stop the non-renewable power generator in response to the measured battery power level data.

16. A method of controlling a thermal management system comprising two cooling loops within a hybrid power system, the method comprising:
setting an acceptable temperature range for a system component coupled to a low-temperature cooling loop;
monitoring system component temperature data; and
initiating the low-temperature cooling loop in response to a temperature level of the system component coupled to the low-temperature cooling loop being outside the acceptable temperature range.

17. The method of claim 16, wherein the low-temperature loop includes at least one heating element, and wherein initiating the low-temperature cooling loop further comprises turning on the at least one heating element to supply heat to the low-temperature cooling loop.

18. The method of claim 16, the method further comprising:
initiating a high-temperature cooling loop in response to the temperature level of the system component coupled to the low-temperature cooling loop being outside the acceptable temperature range.

19. The method of claim 16, wherein the high-temperature cooling loop includes a power generator, and wherein initiating the high-temperature cooling loop further comprises turning on the power generator to supply heat to the low-temperature cooling loop.

20. The method of claim 16, the method further comprising:
setting the acceptable temperature range for the power generator;
monitoring power generator temperature data;
initiating the high-temperature cooling loop in response to a temperature level of the power generator being outside the acceptable temperature range,
wherein the high-temperature cooling loop includes a fan and wherein initiating the high-temperature cooling loop comprises controlling the fan to cool the power generator.
